(19) United States
(12) Patent Application Publication
(10) Pub. No.: US 2015/0007418 A1
(43) Pub. Date: Jan. 8, 2015

(54) Apparatus for removal and replacement of sectional door rollers in situ

(71) Applicant: George Franklin Milton, Jacksonville, FL (US)

(72) Inventor: George Franklin Milton, Jacksonville, FL (US)

(21) Appl. No.: 13/987,164

(22) Filed: Jul. 8, 2013

(51) Int. Cl. E06B 9/58

(52) U.S. Cl. CPC E06B 9/58
USPC 16/95 R

(57) ABSTRACT

The apparatus disclosed is a replacement of existing garage door tracks and a new and unique way to change garage door rollers, panels and guide track roller mounts. Said rollers of prior art have to have the track bent or removed. This task is simply too dangerous for the average homeowner and requires special tools. Said APPARATUS FOR REMOVAL AND REPLACEMENT OF SECTIONAL DOOR ROLLERS IN SITU allows said artisan to remove and to replace said guide track rollers without exposing oneself to the dangerous conditions currently used. Said APPARATUS FOR REMOVAL AND REPLACEMENT OF SECTIONAL DOOR ROLLERS IN SITU allows the homeowner to position said guide track rollers adjacent to either said slot or said hole, remove said guide track roller retaining clip and remove the entire said guide track roller in one piece. Replacement of a damaged guide track roller is the reverse process, simply align a new or undamaged guide track roller into said slot or through said hole and into said guide track roller mount, replace guide track roller retaining clip. Using said guide track cover snapped over guide track slot retains door panels form accidently breaching garage doorframe during use.

### CROSS REFERENCE TO RELATED APPLICATIONS

This application claims the benefit of U.S. Provisional Application No. 61/796,377 filed Nov. 9, 2012, the entire disclosures of which are incorporated herein by reference.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Field of the Invention

This invention relates generally to the U.S. Patent classification definitions technical field of but not limited to Class 160 flexible or Portable Closure, Partition, or Panel/Subclass 49 Movable or Removable Closures and more specifically to a unique and novel apparatus that provides for removal and replacement of sectional-door rollers in situ.

2. Prior Art

Sectional doors which are raised or lowered for the covering of garage openings are typically 5 sectional pans or raised panels connected together and which travel along guide tracks on 4 guide track rollers. Said guide tracks affix by a means to said garage door opening with brackets. Said brackets hold said guide tracks known to artisans in the field as 3 vertical track and 1 horizontal track and 2 12″/15″ return. Either said 3 vertical or 1 horizontal track contain said 2 12″ or 15″ radius track to guide said door from said vertical to horizontal or vice versa.

Due to the many cycles placed on said guide track and said guide track 4 rollers during vertical to horizontal operation said sectional door guide track 4 rollers wear out and break causing said sectional doors to hang and cease movement. Once said 4 guide track rollers damage, they quickly begin to scar, gouge and damage said sectional door 1, 2 & 3 guide tracks. Artisans typically remove said 9 hinge assembly to access said 4 guide roller. In an alternative method, artisans bend said 1 horizontal track or 3 vertical track to replace guide track 4 rollers.

Said removal of guide track, springs (not shown) and said 4 guide rollers is not a task easily undertaken by other then sectional door artisan; therefore, said task is both cost prohibitive as well as dangerous for many homeowners, requires special tools, many hours to complete and must be performed by a professional due to the great amount of tension placed upon said springs (not shown) which assist in raising or lowering said sectional doors from a vertical to horizontal position or any position in between.

Currently, artisans create special tools in welding shops and the like to aid in the replacement and maintenance of said sectional door guide track and rollers. These special tools are no longer needed, as APPARATUS FOR REMOVAL AND REPLACEMENT OF SECTIONAL DOOR ROLLERS IN SITU will change the method in which artisans replace or perform maintenance on said guide track and said guide track 4 rollers.

While there do exist many fanciful apparatus that will attach in all manners to said 3 and said 1 garage door track, they all have similar shortcomings which is none would provide a quick and easy way to remove and to replace damaged 5 sectional door pan section. Specifically said guide track 4 rollers without interfering with the aforementioned 3 and 1 said garage door tracks movement or sacrificing somewhere else. Said APPARATUS FOR REMOVAL AND REPLACEMENT OF SECTIONAL DOOR ROLLERS IN SITU will change the method in which artisans replace or perform maintenance on said guide track and said guide track 4 rollers.

Accordingly, a need remains for APPARATUS FOR REMOVAL AND REPLACEMENT OF SECTIONAL DOOR ROLLERS IN SITU in order to overcome the above-noted shortcomings. The non-limiting exemplary embodiments satisfies such a need by providing an apparatus that is convenient and easy to use, lightweight yet durable in design, versatile in its applications, and designed for easily and conveniently replacing or performing maintenance on said guide track and said guide track 4 rollers.

### BRIEF SUMMARY OF THE INVENTION

In view of the foregoing background, it is therefore an object of the non-limiting exemplary embodiments to provide a brief summary of the invention and some of the advantages such as provide a quick way to remove and replace 9 guide track roller mount. Another advantage is a typical homeowner can now replace damaged garage door Sectional pans or Raised panels.

Described in one embodiment is the 6 slot method of removal.

A 7 hole method is described in another embodiment of the invention.

In still another embodiment is attaching by such as but not limited to, replacement of existing tracks.

An additional embodiment is concealing the 6 slot or 7 hole with a removable, reusable snap in place cover.

This invention APPARATUS FOR REMOVAL AND REPLACEMENT OF SECTIONAL DOOR ROLLERS IN SITU does not interfere with normal operations of the garage door and allows for safer replacement of said track rollers.

These and other objects, features, and advantages of the invention are provided by description of the preferred embodiments.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

It is noted the purpose of the foregoing abstract is to enable the U.S. Patent and Trademark Office and the public generally, especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWING VIEW

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 is a perspective view showing APPARATUS FOR REMOVAL AND REPLACEMENT OF SECTIONAL DOOR ROLLERS IN SITU, in a preferred use installed in said guide tracks known to artisans in the field as 3 vertical track and 1 horizontal track and 2 12″/15″ return and in accordance with the non-limiting exemplary embodiments;

Those skilled in the art will appreciate that the figures are not intended to be drawn to any particular scale; nor are the figures intended to illustrate every embodiment of the invention. The invention is not limited to the exemplary embodiments depicted in the figures or the shapes, relative sizes or proportions shown in the figures.

### DETAILED DESCRIPTION OF THE INVENTION

The non-limiting exemplary embodiments will now be described more fully hereinafter with reference to the accompanying drawings, in which a preferred embodiment of the invention is shown. This invention may, however, be embodied in many different forms and should not be construed as limited to the embodiment set forth herein. Rather, this embodiment is provided so that this application will be thorough and complete, and will fully convey the true scope of the invention to those skilled in the art. Like numbers refer to like elements throughout the figures.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “non-limiting exemplary embodiments” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The below disclosed subject matter is to be considered illustrative, and not restrictive, and the appended claims are intended to cover all such modifications, enhancements, and other embodiments which fall within the true scope of the non-limiting exemplary embodiments. Thus, to the maximum extent allowed by law, the scope of the non-limiting exemplary embodiments is to be determined by the broadest permissible interpretation of the following claims and their equivalents, and shall not be restricted or limited by the foregoing detailed description.

References in the specification to “one embodiment”, “an embodiment”, “a preferred embodiment”, “an alternative embodiment” and similar phrases mean that a particular feature, structure, or characteristic described in connection with the embodiment is included in at least an embodiment of the invention. The appearances of the phrase “non-limiting exemplary embodiment” in various places in the specification are not necessarily all meant to refer to the same embodiment.

Directional and/or relationary terms such as, but not limited to, left, right, nadir, apex, top, bottom, vertical, horizontal, back, front and lateral are relative to each other and are dependent on the specific orientation of an applicable element or article, and are used accordingly to aid in the description of the various embodiments and are not necessarily intended to be construed as limiting.

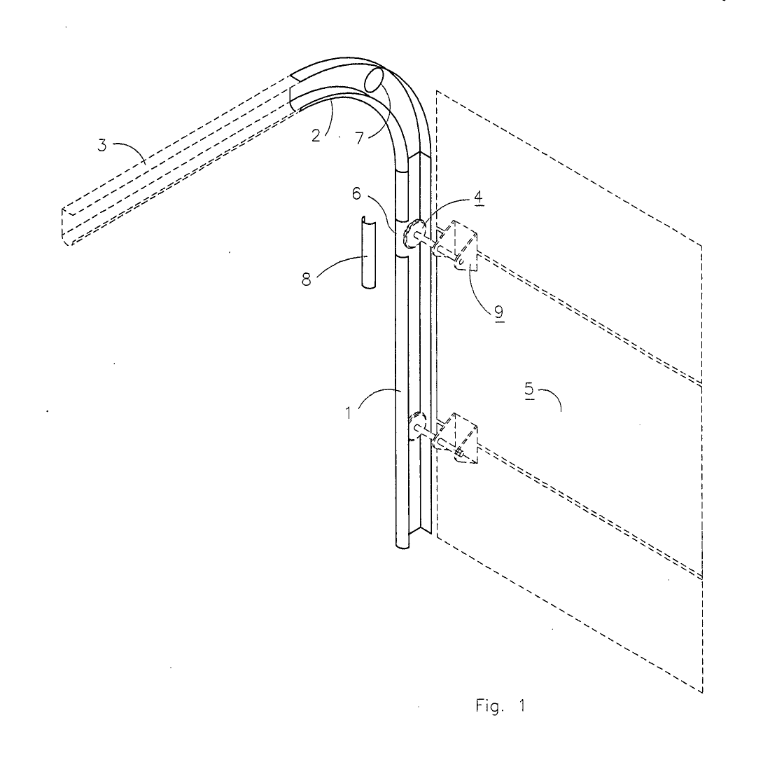

The apparatus of this invention is referred to generally in FIG. 1 and is intended to provide a perspective view showing APPARATUS FOR REMOVAL AND REPLACEMENT OF SECTIONAL DOOR ROLLERS IN SITU attached to a common 21^{st} century garage doorframe typically found in a majority of homes. It should be understood that the non-limiting exemplary embodiments may be used to describe similar apparatus and many different types of devices that could be protected by APPARATUS FOR REMOVAL AND REPLACEMENT OF SECTIONAL DOOR ROLLERS IN SITU and should not be limited to the uses described herein. The descriptor nomenclature legend that follows⁻is not meant to be all-encompassing but to aid the reader in understanding the figures within the drawings.
Item Number 1: Horizontal Track;
Item Number 2: Twelve and Fifteen inch return;
Item Number 3: Vertical Track;
Item Number 4: Guide Track Roller;
Item Number 5: Sectional Pan or Raised Panel;
Item Number 6: Track slot;
Item Number 7: Track Hole;
Item Number 8: Guide Track Cover;
Item Number 9: Guide Track Roller Mount;

Viewing FIG. 1/1, a perspective view, APPARATUS FOR REMOVAL AND REPLACEMENT OF SECTIONAL DOOR ROLLERS IN SITU is shown with descriptors number 1 thru 9 illustrating a first embodiment of the invention. APPARATUS FOR REMOVAL AND REPLACEMENT OF SECTIONAL DOOR ROLLERS IN SITU constructed of a formed ridged material that withstands shock g-force delivered from a moving garage door. Said 6 slot method is herein described as a slotted shaped area removed from said 1 horizontal or 3 vertical track and of sufficient width and length to accommodate said 4 guide track roller to pass through unrestricted. Said 6 slot is covered by said 8 guide track cover. Said guide track cover is affixed by such as but not limited to friction.

Yet in another embodiment and still viewing FIG. 1/1, said 7 hole method involves a circular shaped port through said 1 horizontal or 3 vertical track and of sufficient girth to accommodate said 4 guide track roller to pass through unrestricted. The preferred method of placement of said 7 hole is centered along 2 twelve or fifteen inch returns.

A further embodiment also viewed on FIG. 1/1, is APPARATUS FOR REMOVAL AND REPLACEMENT OF SECTIONAL DOOR ROLLERS IN SITU can be in the preferred method, installed at the manufacturing facility where the garage door track is created and packaged, simply by using said APPARATUS FOR REMOVAL AND REPLACEMENT OF SECTIONAL DOOR ROLLERS IN SITU the manufacture can assure easier assembly of his garage door product as the artisan can take advantage of both said 6 track slot or 7 track hole during assembly.

An additional embodiment viewed on FIG. 1/1, is said 8 guide track cover, said cover is formed for the same material that said track is created. In addition, formed to parallel shape of said 1 horizontal track and 3 vertical track thus can be in the preferred method snapped in place and unsnapped to remove. Said 8 guide track cover is pushed into place or pulled out of place during use and replacing and providing maintenance to said 9 guide track roller mount and said 4 guide track rollers.

A further embodiment viewed on FIG. 1/1 neither said 6 track slot nor 7 track hole interferes with the normal operation of said garage door and allows for a safer means to remove and replace either 4 guide roller or 9 guide track roller mount.

While the invention has been described with respect to a certain specific embodiment, it will be appreciated that many modifications and changes may be made by those skilled in the art without departing from the spirit of the invention. It is intended, therefore, by the appended claims to cover all such modifications and changes as fall within the true spirit and scope of the invention. In particular, with respect to the above description, it is to be realized that the optimum dimensional relationships for the parts of the non-limiting exemplary embodiments may include variations in size, materials, shape, form, function and manner of operation.

what is claimed as new and what is desired to secure by Letters Patent of the United States is:

1. A length of track shaped to guide such as but not limited to a garage door roller along that contains either a hole or a slot capable of accepting said garage door roller for a safer and easier method of replacement and or maintenance of said garage door rollers.
